(19) United States
(12) Patent Application Publication
(10) Pub. No.: US 2009/0121082 A1
(43) Pub. Date: May 14, 2009

(54) Method of locally reinforcing a composite element and reinforced aircraft wing structure central box section

(75) Inventors: Christian Godenzi, Colomiers (FR); Frederic Tanghe, Fonsorbes (FR); Stephane Gay, Toulouse (FR); Nicolas Prioul, Longages (FR)

Correspondence Address: PERMAN & GREEN, 425 POST ROAD, FAIRFIELD, CT, 06824, US

(73) Assignee: AIRBUS FRANCE, Toulouse Cedex 9 (FR)

(21) Appl. No.: 12/244,847

(22) Filed: Oct. 3, 2008

(30) Foreign Application Priority Data
Oct. 4, 2007 (FR) 0758070

(51) Int. Cl. B64C 3/18; B21D 53/92

(52) U.S. Cl. 244/123.1; 29/897.2

(57) ABSTRACT

A method of locally reinforcing an element made of composite material having a longest dimension, such as a composite beam, which is intended to bear multidirectional forces. To do that, at least one metal reinforcing piece is secured to the composite element, at a point on the composite element that is intended to bear vertical forces. The same may be done at each of those points on the composite element that is intended to bear vertical forces.

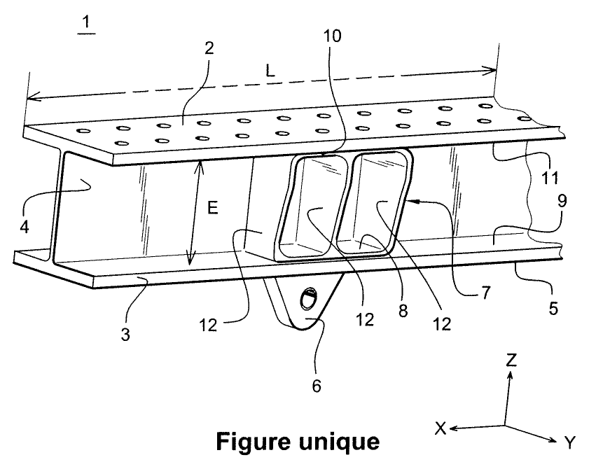

### BACKGROUND

1. Field

The disclosed embodiments relate to a method of locally reinforcing an element made of composite material. More specifically, the disclosed embodiments relate to a method that will allow a composite element to be reinforced only at those points on said element that are intended to bear vertical forces, whereas the fibers of which the composite element is made are essentially arranged in a longitudinal direction. The disclosed embodiments also relate to a wing structure central box section equipped with longitudinal beams made of composite material, in which box section at least one composite beam is locally reinforced so that, at least at the location of the reinforcement, it can bear vertical forces.

2. Brief Description of Related Developments

The method according to the disclosed embodiments finds applications where it is necessary locally, or at isolated points, to reinforce a composite element in such a way that it is able, at the location of these reinforced regions, to bear vertical forces. The method according to the disclosed embodiments is advantageously implemented during the manufacture of elements of aircraft structures, such as longitudinal beams located at the intrados and extrados panels of the wing structure central box section of jumbo jet planes of the Airbus A380 (registered trade name) type.

Until recently, large-sized structural elements, that is to say elements of significant length, have been made of metallic materials such as aluminum alloys, obtained from extruded, machined or forged section pieces. This is because metallic materials, given their homogeneity, on a material scale exhibit a mechanical strength that is constant irrespective of the direction of loading to which the structural element is subjected. Furthermore, such metallic structural elements can be sized for overall loading and for localized loads, such as those generated by the anchoring points of fittings or points supporting equipment, and the direction of which loading differs from the direction of the overall loading. Thus, vertical loads can easily be absorbed at the structural elements using additional thicknesses or local ribs obtained by machining while the structural element overall is sized to absorb mainly longitudinal loads.

However, nowadays, and particularly in the field of aeronautical engineering, it is common practice for structures to be lightened by using composite materials in place of the metallic materials. It is thus known practice for composite section pieces to take the place of the metal section pieces.

Composite section pieces such as this with continuous fibrous reinforcements have very good mechanical properties with respect to loading that make the fibrous reinforcements work in tension or in compression, that is to say longitudinally. These composite section pieces are obtained by techniques of laying up dry fibers or prepregs, followed by a procedure whereby resin is injected or the layup undergoes consolidation baking in an autoclave. Because the fibers are positioned in essentially longitudinal directions, the composite section pieces have mechanical properties that differ widely according to whether the loadings to which they are subjected cause them to work essentially in a longitudinal direction, in tension or compression, or in a vertical direction. Specifically, in the former instance, the strength of the composite section piece is provided by the continuous fibers, whereas in the latter instance, the strength is essentially given by the resin, which has markedly inferior mechanical properties.

Certain composite elements, particularly the longitudinal beams used in the intrados and extrados panels of the central box section of an aircraft wing structure, absorb essentially longitudinal loadings. However, these composite elements may experience localized vertical loadings with respect to a plane in which the composite element runs. Thus, in the case of the longitudinal beams of a wing structure central box section panel, said beams may be loaded vertically at the attachment points of the link rods from which the aircraft ventral fairing is suspended. The longitudinal beams of the intrados panels are thus locally loaded vertically because of the mass of the fairing and its aerodynamic loading in flight, because of the weight of the mechanical and hydraulic systems located in this area, etc.

Unlike metal beams which can have isolated reinforcements using a localized increase in thickness, a solution such as this cannot readily be transferred across to composite beams. Further, because the fibers run longitudinally, locally increasing the thickness would not yield the desired results. In addition, it would be necessary, at the time of manufacture, to known which points on the composite beam were going to have to be able to bear vertical forces.

### SUMMARY

One aspect of the disclosed embodiments is to make it possible locally to reinforce a composite element having a longest dimension, such as composite longitudinal beams, a posteriori, that is to say once the beam has been manufactured, to suit its use. The reinforcement is specifically designed to suit the loadings to which the composite element is intended to be subjected.

Another aspect of the disclosed embodiments is to propose a reinforcement such as this that does not in any way penalize the composite element in terms of mass.

To do that, in the disclosed embodiments, provision is made for at least one metal reinforcing gusset plate to be positioned locally on the composite element in such a way that said gusset plate extends along a height of the composite element that is to be reinforced. What height means is the dimension of the element considered in a vertical plane with respect to the longitudinal axis of said element in question. The gusset plate is specifically positioned at that point on the composite element that is intended to bear vertical forces. As a preference, the metal gusset plate is equipped with one or more web portions extending vertically along the height of the composite element that is to be reinforced, so that a width of said gusset plate extends across a width of said composite element that is to be reinforced. What the width of an element means is the dimension of said element extending transversely with respect to the longitudinal axis of said element. The wall of the web portion extends in a vertical plane perpendicular to the longitudinal axis of the composite element that is to be reinforced. The metal gusset plates used can be mass-produced and fitted to the composite element, also mass-produced, at the locations where vertical strength is required. The gusset plates may be obtained by machining or by forging and are advantageously made of aluminum or titanium alloy or any other metallic material suited to the vertical loadings that the composite element is intended to absorb. In the specific case of a central box section for the wing structure of an aircraft, equipped with composite longitudinal beams, at least one longitudinal beam of an extrados and/or intrados panel of said box section may thus be equipped with one or more metal gusset plates.

A subject of the disclosed embodiments is therefore a method of locally reinforcing an element made of composite material having a longest dimension, such as a composite beam, which is intended to bear multidirectional forces, characterized in that it comprises the following step:

at least one metal reinforcing piece is secured to the composite element, at a point on the composite element that is intended to bear vertical forces.

What local means is that the reinforcement is created only at isolated points where the metal reinforcing piece or pieces are located, as opposed to an overall reinforcement which would cover the entirety of the composite element.

The longest dimension of the composite element means the length of said element, parallel to the longitudinal axis of said composite element. Insofar as the metal reinforcing piece can increase the ability of the composite element to withstand vertical forces, said element is advantageously made up of fibrous reinforcements and of continuous fibers running essentially parallel to the longitudinal axis of said composite element.

The composite element locally reinforced according to the method of the disclosed embodiments is advantageously intended to bear multidirectional forces, and chiefly longitudinal tensile or compressive forces along the longitudinal axis of said composite element, and, at isolated points, that is to say at clearly defined points on the composite element, to bear vertical forces. What vertical forces means is forces along an axis that is vertical with respect to the plane in which the composite element that is to be reinforced extends.

According to some exemplary embodiments of the method according to the disclosed embodiments, it is possible to provide all or some of the following additional features:

an upper wall of the reinforcing piece is secured to an upper flange of the composite element, and a lower wall of said reinforcing piece is secured to a lower flange of said composite element, said reinforcing piece comprising at least one vertical web portion extending between the upper wall and the lower wall, transversely to the longitudinal axis of the element made of composite material;

the composite element is equipped with a central web extending between the two flanges, and at least two reinforcing pieces are secured to said beam, one on each side of the central web;

the composite element is an aircraft longitudinal beam.

The disclosed embodiments also relate to a wing structure central box section for an aircraft equipped with longitudinal beams made of composite material, characterized in that at least one composite longitudinal beam comprises at least one metal reinforcing piece extending along a height of said longitudinal beam so as to absorb vertical forces applied locally to said longitudinal beam.

What longitudinal means is that the longitudinal axis of the beams runs parallel to the longitudinal axis of the aircraft in which the wing structure central box section is intended to be housed. What height means is the dimension of the beam extending between the two flanges of said beam.

According to some exemplary embodiments of the wing structure central box section according to the disclosed embodiments it is possible to provide all or some of the following additional features:

the reinforcing piece comprises an upper wall secured to an upper flange of the longitudinal beam, a lower wall secured to a lower flange of said longitudinal beam and at least one vertical web portion extending between the upper and lower walls of said reinforcing piece;

the upper wall and the lower wall of the reinforcing piece run parallel to the flanges of the longitudinal beam, the vertical web portion running at right angles to said flanges and to the web of the longitudinal beam;

the reinforcing piece comprises at least two vertical web portions so that said reinforcing piece has a closed section;

at least one composite longitudinal beam of the intrados panel and/or the extrados panel of said box section is equipped with at least one metal reinforcing piece.

The disclosed embodiments will be better understood from reading the description which follows and from examining the accompanying single FIGURE. This is given by way of entirely nonlimiting indication of the disclosed embodiments. The FIGURE depicts a schematic part view of a composite beam locally reinforced with a reinforcing piece according to the disclosed embodiments.

### DETAILED DESCRIPTION OF THE DISCLOSED EMBODIMENTS

The example described hereinbelow is aimed at the special case of a beam made of composite material. Of course, the reinforcing method according to the disclosed embodiments may be applied in exactly the same way to any structural element that has a longest dimension and that requires isolated reinforcement intended to make it capable of withstanding vertical forces.

The single FIGURE partially depicts a composite longitudinal beam 1. A longitudinal axis of the beam 1 runs parallel to the X-axis of the X Y Z frame of reference of an aircraft in which such a longitudinal beam is intended to be housed. More specifically, the longitudinal beam as depicted in the FIGURE is intended to form part of an extrados panel or of an intrados panel of the central box section of the wing structure of an aircraft.

The beam 1 comprises an upper sole or flange 2 and a lower sole or flange 3, these being parallel and separated from one another by a vertical web 4. The web 4 extends in a plane perpendicular to the planes of the two soles 2 and 3. The web 4 extends over the entire length L of the beam 1 so that the beam 1 is an I-section beam. What length means is the dimension of the beam running parallel to the longitudinal X-axis of the aircraft in which the beam 1 is intended to be housed.

The beam 1 is made of composite material, the direction of the continuous fibers being essentially longitudinal. An underside 5 of the lower sole 3 comprises a fitting 6 intended to act as an anchoring point for a vertical or oblique link rod (not depicted). If the beam 1 is a beam of the extrados panel of the central box section of the wing structure, then the link rod secured to the fitting 6 connects the beam 1 to an aircraft floor rail. If the beam 1 is a beam of the intrados panel of the central box section of the wing structure, then the vertical or oblique link rod secured to the fitting 6 supports the ventral fairing of the aircraft. In all events, the beam 1 is intended, at the location of the fitting 6, to bear vertical forces. In the X Y Z frame of reference of the airplane, the vertical forces are the forces along the Z-axis.

According to the reinforcing method of the disclosed embodiments, a metal reinforcing piece 7 intended to absorb vertical forces is fitted at the site of the fitting 6. According to the method of the disclosed embodiments, it is possible to equip the beam 1 with metal pieces 7 at the site of each fitting 6.

Advantageously, in the case of an I-beam like the one depicted in the FIGURE, two identical metal reinforcing pieces 7 are fitted, one on each side of the web 4, so that each of the flanks of the beam 1 is vertically reinforced. In the case of a C-section beam, just one metal reinforcing piece 7 at the site of a fitting 6 will suffice.

The metal reinforcing piece 7 comprises a lower wall 8 secured to the internal face 9 of the lower sole 3. What internal means is the face directed toward the volume created between the two soles 2 and 3 of the beam 1, and what external means is the face directed toward the outside of the beam 1. An upper wall 10 of the metal reinforcing piece 7 is secured to an internal face 11 of the upper sole 2. The upper 10 and lower 8 walls of the metal reinforcing piece 7 are secured by any means to the internal faces 11, 9 of the soles 2, 3 along which they run.

The metal reinforcing piece 7 also comprises three web portions 12, or vertical walls, running vertically between the lower 8 and upper 10 walls of the metal reinforcing piece 7. The web portions 12 are secured by two opposite ends to the lower wall 8 and to the upper wall 10 such that they extend along a height E of the beam 1. What height means is the dimension of the beam extending between the two soles 2, 3. Thus, the web portions 12 of the metal reinforcing piece 7 run in a direction parallel to the vertical forces to which the beam 1 is intended to be subjected.

Each web portion 12 runs in a plane perpendicular both to the plane of the soles 2, 3 and to the plane containing the web 4 of the beam 1. The metal reinforcing piece 7 thus forms a box section locally reinforcing the beam 1 and thus rendering it capable of bearing vertical forces. This in particular makes it possible to reduce the risks of pull-out or buckling failure in the regions of the beam 1 that have low load-bearing capabilities.

The method according to the disclosed embodiments is particularly advantageous in reducing the cost of manufacture of longitudinal beams, insofar as it is possible for composite beams to be mass-produced in the known way, without the need to worry about the points which later will be vertically loaded, the points of loading varying according to their end-use. Once the beam has been manufactured, and its end-use has been determined, the link rod anchoring points are fitted. The beam 1 can then be locally reinforced using the metal reinforcing pieces 7.

In terms of mass, this makes it possible not to needlessly increase the total weight of the composite beam, because said beam is only reinforced at the points where it is needed.

The vertical forces applied to the beam 1 are transmitted via the metal reinforcing piece 7 to the surrounding structure, this relieving the load on those regions of said beam 1 that have a low load-bearing capability.

The number of vertical web portions 12 can of course vary and may, in particular, be dependent on the level of vertical force to which the beam 1 is intended to be subjected.

In the case of an I-section beam, such as a wing structure central box section intrados longitudinal beam, the metal reinforcing pieces 7 are adjusted in terms of width by an interposed resin and are fixed to the flanges of the I by fasteners of the rivet type in the case of the soles or directly using the fasteners that connect the panels to the beam. As a preference, the end wall of the metal reinforcing piece 7 is also fixed to the web of the I so as to stabilize it in terms of buckling.

Thus, in the case of an I-beam made of carbon-epoxy composite, associated with a fiber-laying sequence suitable for absorbing the overall forces in this region, and in which the web thickness is 5 mm and the flange thickness is 7 mm, use is made of an aluminum metal reinforcing piece 7 with an end wall thickness of 2 mm, in contact with the web 4 of the beam 1, the upper 2 and lower 3 soles of which have a thickness of 4 mm. A beam 1 such as this, with no reinforcing gusset plate, is able to absorb localized transverse forces of one metric ton, whereas the same beam equipped with a metal reinforcing piece 7 according to the disclosed embodiments is capable of absorbing localized transverse forces of 3.5 metric tons.

1. A method of locally reinforcing a beam made of composite material having a longest dimension, said beam being equipped with a central web extending between two flanges, and being intended to bear multidirectional forces, comprising:
at least two metal reinforcing pieces rare secured to the beam, one on each side of the central web, at a point on the beam that is intended to bear forces that are vertical with respect to the plane in which the beam extends, one reinforcing piece extending along a height of said longitudinal beam.

2. The method according to claim 1, further comprising:
securing the at least two metal reinforcing pieces at each of those points on the beam that is intended to bear forces that are vertical with respect to the plane in which the beam extends.

3. The method according to claim 1, further comprising:
securing an upper wall of the reinforcing piece is secured to an upper flange of the composite beam, and a lower wall of said reinforcing piece is secured to a lower flange of said beam, said reinforcing piece comprising at least one vertical web portion extending between the upper wall and the lower wall, transversely to the longitudinal axis of the element made of composite material.

4. The method according to claim 1, wherein the composite beam is an aircraft longitudinal beam.

5. The wing structure central box section for an aircraft equipped with longitudinal beams made of composite material each comprising a central web extending between two flanges, wherein at least one composite longitudinal beam comprises at least two metal reinforcing pieces positioned one on each side of the central web, one reinforcing piece extending along a height of said longitudinal beam, so as to absorb forces that are vertical with respect to the plane in which the composite element that is to be reinforced extends, these forces being applied locally to said longitudinal beam.

6. The wing structure central box section according to claim 5, wherein the reinforcing piece comprises an upper wall secured to an upper flange of the longitudinal beam, a lower wall secured to a lower flange of said longitudinal beam and at least one vertical web portion extending between the upper and lower walls of said reinforcing piece.

7. The wing structure central box section according to claim 6, wherein the upper wall and the lower wall of the reinforcing piece run parallel to the flanges of the longitudinal beam, the vertical web portion running at right angles to said flanges and to the web of the longitudinal beam.

8. The wing structure central box section according to claim 6, wherein the reinforcing piece comprises at least two vertical web portions so that said reinforcing piece has a closed section.

9. The wing structure central box section according to claim 5, wherein at least one composite longitudinal beam of the intrados panel and/or the extrados panel of said box section is equipped with at least one metal reinforcing piece.
